(19) United States
(12) Patent Application Publication
(10) Pub. No.: US 2023/0025143 A1
(43) Pub. Date: Jan. 26, 2023

(54) GAS-PERMEABLE ELEMENT FOR A RECEPTACLE

(71) Applicant: AIRNOV, INC., WILMINGTON, NEW CASTLE, DE (US)

(72) Inventors: Jacquy Lebon, Challands (FR); Valere Logel, Levallois Perret (FR); Dominique Bois, Montreuil aux Lions (FR)

(21) Appl. No.: 17/758,243

(22) PCT Filed: Dec. 31, 2020
(86) PCT No.: PCT/EP2020/088072

§ 371 Date: Jun. 30, 2022

(30) Foreign Application Priority Data
Jan. 3, 2020 (EP) 20150265.5

(51) Int. Cl. B01D 53/04; B01D 53/26

(52) U.S. Cl. CPC B01D 53/0407; B01D 53/261; B01D 2251/40; B01D 2253/20

(57) ABSTRACT

A gas-permeable element configured to close a receptacle base containing an active material, wherein the receptacle includes the receptacle base and the gas-permeable element. The gas-permeable element includes a body, having a base wall, including at least one opening. For each opening of the base wall, the body includes a tubular projection projecting from a periphery of the opening. The tubular projection includes a first end, connected to the periphery of the opening, a second end, defining a distal edge surface transverse to a longitudinal axis of the tubular projection. A porous membrane portion extends across the second end of the tubular projection while attached to the distal edge surface at its periphery.

### FIELD OF THE INVENTION

The present invention relates to a gas-permeable element configured to close a base of a receptacle having an active material in its inner volume, the receptacle thus obtained permitting gases and vapors to enter through the gas-permeable element to interact with the active material received in the base. In particular, the receptacle comprising the base closed by the gas-permeable element may be a canister, a stopper, or a compartment defined in a packaging, notably for use in a packaging filled with sensitive and/or odorous products such as food, nutraceutical products, pharmaceutical products or diagnostic products, or a compartment defined in a medical device, notably in an inhaler such as a DPI (Dry Powder Inhaler). The present invention also relates to a method and an apparatus for manufacturing a gas-permeable element.

### BACKGROUND OF THE INVENTION

Receptacles filled with a desiccant material are conventionally used in packaging or in medical devices such as inhalers. Such receptacles are formed from gas and liquid impermeable elements comprising perforations, the desiccant material received in the inner volume of the receptacle thus being capable of adsorbing moisture present in the packaging or medical device as it flows through the perforations. However, one problem of conventional desiccant receptacles is that the desiccant material received in the receptacle often includes fine particles, which may escape from the receptacle and contaminate the products contained in the packaging or the medical device.

In order to reduce the risk of contamination, receptacles have been proposed where openings of the receptacle are closed by a porous membrane allowing moisture to flow toward the interior of the receptacle. In particular, WO 2016/108869 A1 discloses a canister comprising, on at least one of its ends, openings that are closed by a membrane. More precisely, the periphery of the membrane is positioned between a base wall of the canister and an annular retaining lip. However, the manufacturing of such a canister by injection molding is complex, since it requires that the membrane be placed in a mold cavity in which the membrane is not retained laterally. The periphery of the membrane, which is expected to become embedded between the base wall and the surrounding retaining lip, is free on both sides and is not supported by any surface of the mold cavity. Then, the membrane may be bent at its periphery by the flow of molten thermoplastic material, which may generate voids between the membrane and the base wall of the canister. This does not ensure a qualitative attachment of the membrane at its periphery and, since the membrane is not fixed at its periphery in a reliable manner, there remains a risk of leaks of active material out of the canister, at the interface between the membrane and the walls of the canister.

It is these drawbacks that the invention is intended more particularly to remedy by proposing a gas-permeable element making it possible to obtain a significant reduction of the risk that active material escapes from a receptacle comprising said gas-permeable element, the manufacturing of the gas-permeable element being simple and predictable so that it can be easily automated, in a reliable manner and with a better efficiency.

### DISCLOSURE OF THE INVENTION

For this purpose, a subject of the invention is a gas-permeable element configured to close a receptacle base having an active material in its inner volume, the receptacle comprising the receptacle base filled with the active material and closed by the gas-permeable element being suitable for the regulation of an atmosphere out of the receptacle, in particular an atmosphere in a packaging or a medical device filled with sensitive and/or odorous products, said gas-permeable element comprising a body based on a polymer material, having a base wall including at least one opening, wherein for each opening of the base wall:
the body comprises a tubular projection projecting from the periphery of the opening, the tubular projection comprising a first end connected to the periphery of the opening and a second end defining a distal edge surface transverse to a longitudinal axis of the tubular projection; and
a porous membrane portion extends across the second end of the tubular projection while being attached to the distal edge surface at its periphery,

wherein, in the configuration where the gas-permeable element closes a receptacle base having an active material in its inner volume, the or each membrane portion separates the active material from the exterior of the receptacle.

Thanks to its specific structure including at least one tubular projection extending from the periphery of the opening, the gas-permeable element according to the invention can be manufactured, in a simple and reliable manner, by injection molding of the body over the membrane portion(s), with the possibility of immobilizing each membrane portion relative to the mold cavity. Then, the quality of the attachment of each membrane portion to the distal edge surface is optimized, which is key for the performance of the gas-permeable element in terms of limiting the escape of fine particles through the gas-permeable element.

According to one embodiment, the base wall of the body comprises at least two openings. The openings are advantageously distributed around a center portion of the base wall, so that the center portion can correspond to the location of the gate of an injection mold used to produce the body of the gas-permeable element by injection molding. The arrangement of the injection point in a center portion of the base wall of the body makes it easier to manufacture the body by injection molding, by ensuring a homogeneous distribution of the molten thermoplastic material on all the periphery of the body.

According to one embodiment, the body is an injection molded part, obtained by injection molding of a thermoplastic material over the membrane portion(s). Advantageously, each membrane portion is attached to the distal edge surface of the tubular projection directly upon forming the body by injection molding, notably by being chemically bonded, thermally bonded and/or mechanically bonded to the distal edge surface of the tubular projection. In one embodiment, the attachment of each membrane portion may result from a mechanical adherence between the constitutive materials of the body and the membrane portion, e.g. in the case of a metallic membrane portion comprising a rough surface on which the molten thermoplastic material constituting the body is injected and gripped in the cooling phase. In other embodiments, the attachment of each membrane portion may result from a partial fusion of the constitutive materials of the body and the membrane portion, or from a chemical or thermal bonding at the interface between the body and the membrane portion.

Examples of suitable polymer materials for the body include, without limitation, radical or linear high- and low-density polyethylene, copolymers of ethylene such as for example ethylene vinyl acetates, ethylene ethyl acrylates, ethylene butyl acrylates, ethylene maleic anhydrides, ethylene alpha olefins, regardless of the methods of polymerization or modification by grafting, polypropylene, polybutylene, polyisobutylene. Polyolefins are advantageously selected to make the body, for cost reasons and because they are easy to use. However, other polymer materials can also be considered, such as polyvinyl chloride, copolymers of vinyl chloride, polyvinylidene chlorides, polystyrenes, copolymers of styrene, derivatives of cellulose, polyamides, polycarbonates, polyoxymethylenes, polyethylene terephthalates, polybutylene terephthalates, copolyesters, polyphenylene oxides, polymethyl methacrylates, copolymers of acrylate, fluoride polymers, polyimides, polyurethanes, etc.

Combinations of these polymers can be used, if desired. The polymers used to produce the body can also contain one or more additives such as fibers, expanding agents, additives such as stabilizers and colorants, sliding agents, demolding agents, adhesion agents or reinforced catching agents and/or any others according to the requirements of usage. According to one embodiment, the polymer material constituting the body can be formulated with one or more additives which are themselves active materials, e.g. belonging to the group of: humidity absorbers; oxygen scavengers; odor absorbers; and/or emitters of humidity or volatile olfactory organic compounds.

According to one embodiment, each membrane portion is a polymer membrane portion, such as a textile or fabric comprising polymer fibers, woven or non-woven, or a perforated polymer film. Examples of polymer fabrics that may be used for the or each membrane portion include non-woven fabrics based on polyethylene or polypropylene fibers. In particular, suitable materials include the products sold by DUPONT under the trademark TYVEK, which are spun-bonded non-woven fabrics comprising polyethylene fibers, in particular based on high-density polyethylene (HDPE) fibers. Examples of perforated polymer films that may be used for the or each membrane portion include perforated films of polyethylene or polypropylene.

According to other embodiments, each membrane portion may be a porous sheet of a material other than a polymer material, for example a metallic fabric or a perforated metallic sheet. In such cases, the attachment of the membrane portion to the distal edge surface of the tubular projection may be obtained by means of a rough surface of the membrane portion on which the molten thermoplastic material constituting the body is injected.

According to one embodiment, each membrane portion comprises holes having a mean diameter less than or equal to 0.10 mm, preferably less than or equal to 0.05 mm. It is understood that, within the meaning of the invention, the diameter of a hole of a membrane portion is the diameter of a circle in which the hole is inscribed.

According to one embodiment, the constitutive materials of the body and each membrane portion are chemically compatible so that each membrane portion is bonded to the distal edge surface of the tubular projection under the effect of the heat and/or the pressure generated during injection molding. Examples of combinations of chemically compatible materials for the body and the membrane portion which may be used within the invention include: a high-density polyethylene (HDPE) thermoplastic resin for the body and a non-woven fabric comprising polyethylene fibers for the membrane portion, such as TYVEK manufactured by DUPONT; a polypropylene (PP) thermoplastic resin for the body and a non-woven fabric comprising polypropylene (PP) fibers for the membrane portion. The bonding of each membrane portion to the distal edge surface of the tubular projection is advantageously obtained directly by injection molding, through injection of the constitutive thermoplastic material of the body in a mold in which each membrane portion has previously been positioned.

According to one embodiment, the height of each tubular projection, taken perpendicular to the base wall, is higher than or equal to the thickness of the membrane portion, preferably higher than or equal to twice the thickness of the membrane portion. When the gas-permeable element is obtained by injection molding, such a height of each tubular projection ensures that the corresponding membrane portion is securely immobilized relative to the mold cavity before the injection of the thermoplastic material. According to one embodiment, the height of each tubular projection, taken perpendicular to the base wall, is higher than or equal to 0.2 mm, preferably higher than or equal to 0.5 mm. Each membrane portion may typically have a thickness of between 0.2 mm and 1 mm, without being limited to this range of values.

According to one embodiment, each tubular projection projects from a side of the base wall which is opposite from the side comprising the injection point for the molding of the body. In this way, the flow of molten thermoplastic material tends to push and immobilize the membrane portion against the part which supports the membrane portion in the molding apparatus.

According to one embodiment, the width of the distal edge surface of each tubular projection, taken transversally to the longitudinal axis of the tubular projection, is between 0.5 mm and 5 mm, preferably between 0.5 mm and 1.5 mm. Of course, the value to be selected for the width of the distal edge surface may depend on the height of the tubular projection and/or the diameter of the opening. The above range for the width of the distal edge surface ensures that the surface area for the attachment of the membrane portion to the tubular projection is sufficient, while limiting the risk that the periphery of the membrane portion folds in the part of the mold cavity where the distal edge surface is to be formed. Such a folding of the membrane portion at its periphery should be avoided, as it may generate defects in the attachment of the membrane and thus impair the performance of the gas-permeable element in terms of limiting the escape of fine particles.

According to one embodiment, for each opening of the base wall, the body comprises at least one transverse rib extending across the second end of the tubular projection and forming an additional attachment surface for the membrane portion, which is preferably flush with the distal edge surface of the tubular projection. With such a structure of the body including transverse ribs, the fastening of each membrane portion to the body is improved, thanks to an increased bonding surface area between the membrane portion and the body, and the resulting gas-permeable element is more reliable to avoid escape of fine particles of active material.

According to one embodiment, the tubular wall of each tubular projection is tapered from its first end joined to the periphery of the opening toward its second end, with a draft angle of less than 5°. When the gas-permeable element is obtained by injection molding, such a draft angle of each tubular projection lowers the risks of damage during release of the part from the mold, so that the production rate can be enhanced by reducing the time required for the cooling phase. According to one embodiment, the value of the draft angles of each tubular projection is selected to be between 0.5° and 1°, preferably of the order of 0.5°.

According to one embodiment, the body includes a side wall projecting from the base wall substantially parallel to each tubular projection, and the distance between the tubular projection and the portion of the side wall closest to the tubular projection is at least 2 mm, preferably at least 3 mm. Such a distance between each tubular projection and the side wall makes it possible to reinforce the mechanical resistance of the mold parts delimiting the cavity for the tubular projection and the side wall.

According to one embodiment, each tubular projection of the body is intended to project toward the interior of the receptacle, i.e. toward the volume of the receptacle intended to receive an active material, and the base wall of the body comprises at least one passage connecting the periphery of the base wall and the or each tubular projection in such a way that gases can circulate in the passage(s) from the exterior toward the interior of the receptacle when the base wall is applied against a surface. Such an arrangement ensures that a receptacle including the gas-permeable element is still active to regulate the atmosphere when the base wall of the body lies on a plane surface. In particular, each passage may be a groove formed on the side of the base wall opposite from the tubular projection(s).

Another subject of the invention is a receptacle comprising a receptacle base, filled or intended to be filled with an active material, and a gas-permeable element as described above for closing the receptacle base. The active material may be any type of active material. Within the meaning of the invention, an active material is a material capable of regulating the atmosphere in a container, especially in a container intended to receive sensitive and/or odorous products. In particular, the active material may belong to a group of: humidity absorbers; oxygen scavengers; odor absorbers; and/or emitters of humidity or volatile olfactory organic compounds. Optionally, the active material may be capable of releasing gaseous substances such as moisture or perfume. Such properties can for example be useful for applications where sensitive products require a certain humidity level. Such products are, for example, powders, especially for generating aerosols, gelatin capsules, herbal medicine, gels and creams including cosmetics, and food products.

Examples of suitable dehydrating agents include, without limitation, silica gels, dehydrating clays, activated alumina, calcium oxide, barium oxide, natural or synthetic zeolites, molecular or similar sieves, or deliquescent salts such as magnesium sulfide, calcium chloride, aluminum chloride, lithium chloride, calcium bromide, zinc chloride or the like. Preferably, the dehydrating agent is a molecular sieve and/or a silica gel.

Examples of suitable oxygen collecting agents include, without limitation, metal powders having a reducing capacity, in particular iron, zinc, tin powders, metal oxides still having the ability to oxidize, in particular ferrous oxide, as well as compounds of iron such as carbides, carbonyls, hydroxides, used alone or in the presence of an activator such as hydroxides, carbonates, sulfites, thiosulfates, phosphates, organic acid salts, or hydrogen salts of alkaline metals or alkaline earth metals, activated carbon, activated alumina or activated clays. Other agents for collecting oxygen can also be chosen from specific reactive polymers such as those described for example in the patent documents U.S. Pat. No. 5,736,616 A, WO 99/48963 A2, WO 98/51758 A1 and WO 2018/149778 A1.

In one embodiment of the invention, the receptacle comprising a receptacle base and a gas-permeable element as described above for closing the receptacle base is a canister intended to be dropped in a container intended to receive sensitive and/or odorous products and regulate the atmosphere inside the container.

In another embodiment of the invention, the receptacle comprising a receptacle base and a gas-permeable element as described above for closing the receptacle base is a stopper configured to close a container intended to receive sensitive and/or odorous products and regulate the atmosphere inside the container.

In yet another embodiment of the invention, the receptacle comprising a receptacle base and a gas-permeable element as described above for closing the receptacle base is a compartment in a container such as a box or a vial for the storage of products, in particular sensitive and/or odorous products. In particular, the compartment may be defined in the container by a gas-permeable cap delimiting two compartments located on both sides of the cap, including a compartment for an active material on one side and a fillable tank for the storage of products on the other side. According to one feature, the cap has a tubular side wall with an open end on the opposite side from the base wall, and the cap is positioned in the container such that the open end faces away from a transverse wall of the container. In this way, the inner volume of the cap is part of the Tillable tank, and products can be stored therein.

Another subject of the invention is a method for manufacturing a gas-permeable element configured to close a receptacle base having an active material in its inner volume; said gas-permeable element comprising a body based on a polymer material, having a base wall with at least one opening and, for each opening, a tubular projection projecting from the periphery of the opening with a first end connected to the periphery of the opening and a second end defining a distal edge surface transverse to a longitudinal axis of the tubular projection; said gas-permeable element further comprising, for each opening of the body, a porous membrane portion extending across the second end of the tubular projection while being attached to the distal edge surface of the tubular projection at its periphery; wherein said method comprises the molding of the body over the or each membrane portion attached to the distal edge surface of a corresponding tubular projection of the body; wherein said method further comprises steps of:
cutting the or each membrane portion with a shape suitable for closing the second end of the corresponding tubular projection of the body;
positioning the or each membrane portion in a predetermined position in a mold comprising a mold cavity for the molding of the body, the predetermined position being such that the membrane portion faces an end of the mold cavity in which the distal edge surface of the corresponding tubular projection is to be formed;
injecting a thermoplastic material into the mold cavity so as to form the body and bond the or each membrane portion with the body at the distal edge surface of the corresponding tubular projection.

According to one embodiment, each membrane portion is cut by means of a punch, the punch being further used to position the membrane portion in its predetermined position facing said end of the mold cavity and to close the mold cavity before the injection of the thermoplastic material.

According to one embodiment, each membrane portion is cut out of a web of membrane material circulating in front of a punch for cutting the membrane portion, the web of membrane material extending from a first reel, from which it is unwound before a cutting operation, to a second reel, on which it is wound after a cutting operation.

According to one embodiment, for the manufacturing of several gas-permeable elements, the web of membrane material is cut according to a pattern in which the holes resulting from the cutting of membrane portions are distributed regularly over the surface of the web, e.g. in staggered rows. In this way, it is possible to avoid weakening the web of membrane material in a too localized manner, and thus lower the risk that the web of membrane material breaks or deforms when it is pulled, e.g. between two reels.

The invention also relates to a gas-permeable element obtained by the method as described above.

Another subject of the invention is an apparatus for the manufacturing of a gas-permeable element, comprising:
a mold including a mold cavity for the molding of the body by injection of a thermoplastic material;
at least one punch, each punch being configured for the cutting of a membrane portion out of a web of membrane material;
   wherein, for each punch, the mold comprises a channel connected to the mold cavity, the punch being configured to slide in the channel from a first position where it cuts a membrane portion, to a second position where it closes the mold cavity while being surrounded by the channel and holding the cut membrane portion such that it faces an end of the mold cavity in which the distal edge surface of the corresponding tubular projection is to be formed.

According to one embodiment, the apparatus further comprises a system, in particular a reel to reel system, for circulating a continuous web of membrane material in front of the at least one punch for the cutting of each membrane portion.

### BRIEF DESCRIPTION OF THE DRAWINGS

Features and advantages of the invention will become apparent from the following description of embodiments of a gas-permeable element, a receptacle comprising a receptacle base closed by the gas-permeable element, a method and an apparatus according to the invention, this description being given merely by way of example and with reference to the appended drawings in which:

FIG. 1 is a perspective view of a receptacle comprising a gas-permeable element according to a first embodiment of the invention, the gas-permeable element being a gas-permeable cap and the receptacle being a canister which comprises a canister base delimiting a chamber for an active material and the gas-permeable cap for closing the canister base;

FIG. 2 is a cross section according to plane II-II of FIG. 1;

FIG. 3 is a cross section at larger scale of the gas-permeable cap of FIGS. 1 and 2;

FIG. 4 is a schematic cross section of an apparatus for manufacturing the gas-permeable cap of FIGS. 1 to 3, the apparatus being in a first configuration;

FIG. 5 is a schematic cross section similar to FIG. 4, the apparatus being in a second configuration;

FIG. 6 is a schematic cross section similar to FIG. 4, the apparatus being in a third configuration;

FIG. 7 is a schematic cross section similar to FIG. 4, the apparatus being in a fourth configuration;

FIG. 8 is a view at larger scale of the detail VIII of FIG. 7;

FIG. 9 is a perspective view similar to FIG. 1 for a receptacle comprising a gas-permeable element according to a second embodiment of the invention, the gas-permeable element being a gas-permeable cap and the receptacle being a canister which comprises a canister base delimiting a chamber for an active material and the gas-permeable cap for closing the canister base;

FIG. 10 is a cross section according to plane X-X of FIG. 9;

FIG. 11 is a cross section at larger scale of the gas-permeable cap of FIGS. 9 and 10;

FIG. 12 is a perspective view of a gas-permeable cap according to a first variant of the second embodiment;

FIG. 13 is a cross section according to plane XIII-XIII of FIG. 12;

FIG. 14 is a perspective view of a gas-permeable cap according to a second variant of the second embodiment;

FIG. 15 is a cross section according to plane XV-XV of FIG. 14;

FIG. 16 is a perspective view similar to FIG. 1 for a receptacle comprising a gas-permeable element according to a third embodiment of the invention, the gas-permeable element being a gas-permeable cap and the receptacle being a compartment in a vial which comprises a compartment base delimiting a chamber for an active material and the gas-permeable cap for closing the compartment base;

FIG. 17 is a cross section according to plane XVII-XVII of FIG. 16;

FIG. 18 is a cross section at larger scale of the gas-permeable cap of FIGS. 16 and 17;

FIG. 19 is a cross section similar to FIG. 2 for a receptacle comprising a gas-permeable element according to a fourth embodiment of the invention, the gas-permeable element being a gas-permeable cap and the receptacle comprising a stopper base delimiting a chamber for an active material and the gas-permeable cap for closing the stopper base; and

FIG. 20 is a cross section at larger scale of the gas-permeable cap of FIG. 19.

It is noted that, in the appended drawings, only the essential elements for understanding the invention have been represented, and this without regard to the scale and in a schematic manner. In particular, the appended drawings may not be accurate with regard to the relative dimensions of the different elements.

### ILLUSTRATIVE EMBODIMENTS OF THE INVENTION

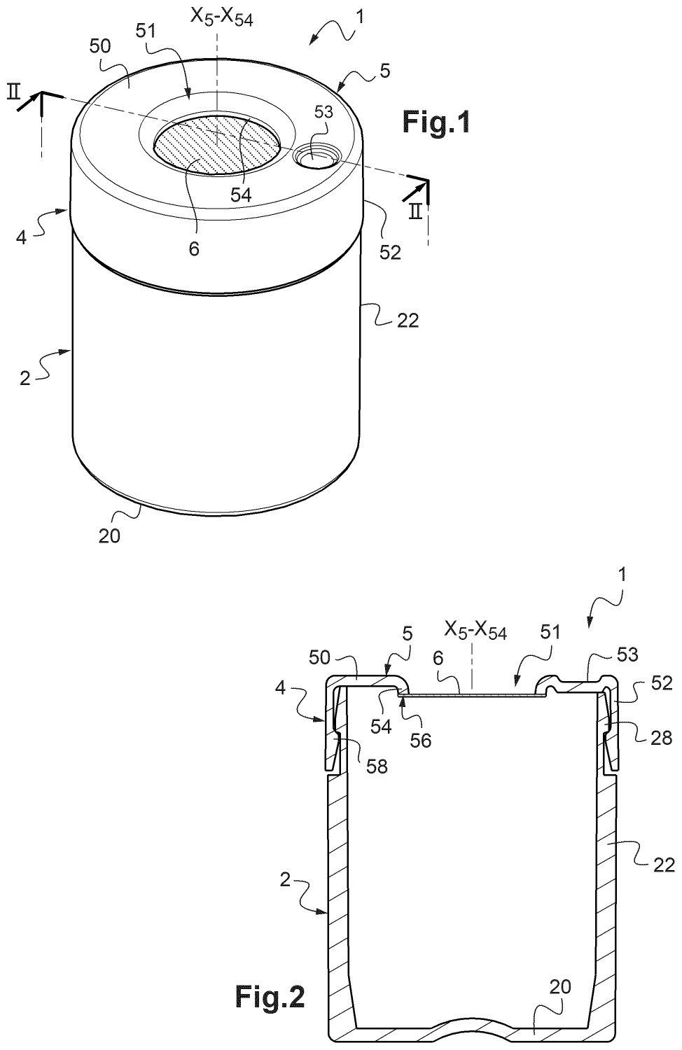

In the first embodiment shown in FIGS. 1 to 8, the gas-permeable element according to the invention is a gas-permeable cap 4 configured to be fastened on a tubular tank 2 to form a canister 1. The tank 2 has a circular cross section and comprises a transverse wall 20 and a peripheral wall 22 delimiting a volume for receiving an active material, which is closed by the gas-permeable cap 4. For the attachment of the gas-permeable cap 4 relative to the tank 2, the tank 2 and the cap 4 comprise complementary clipping members 28 and 58. By way of a non-limiting example, the active material received in the inner volume of the canister 1 may be a dehydrating agent (or desiccant) in a powder or granular form, e.g. selected from molecular sieves, silica gels and/or dehydrating clays. The canister 1 is intended to be dropped in a container (not represented) in which sensitive and/or odorous products are stored, so as to regulate the atmosphere inside the container.

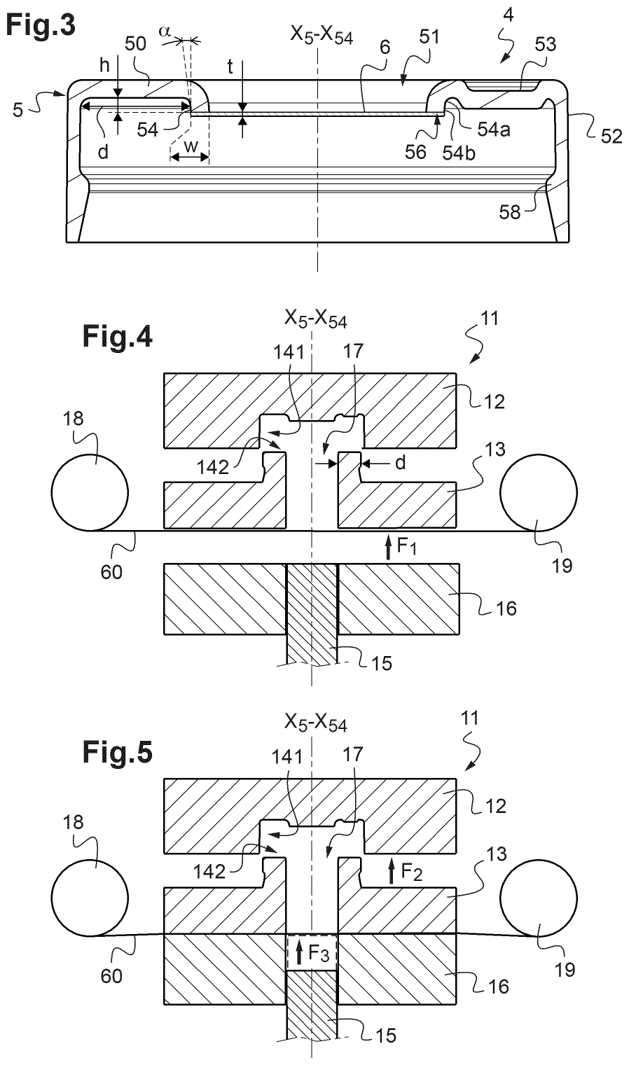

The gas-permeable cap 4 comprises a body 5 and a porous membrane disc 6. The body 5 has a tubular shape with a circular cross section and comprises a base wall 50 and a side wall 52 projecting from the base wall 50 substantially perpendicular thereto. The base wall 50 includes a central opening 51 and a tubular projection 54 projecting from the periphery of the opening 51 substantially perpendicular to the base wall 50. In this way, the longitudinal axis X54 of the tubular projection 54 coincides with the longitudinal axis X5 of the body 5. As clearly visible in FIG. 3, the tubular projection 54 comprises a first end 54a connected to the periphery of the opening 51 and a second end 54b defining a distal edge surface 56 transverse to the longitudinal axis X54 of the tubular projection 54. The membrane disc 6 extends across the second end 54b of the tubular projection while being attached to the distal edge surface 56 at its periphery.

In the assembled configuration of the gas-permeable cap 4 with the tank 2, the tubular projection 54 projects toward the interior of the canister 1, i.e. toward the volume of the canister 1 intended to receive the active material. In one embodiment (not represented), the base wall 50 of the body 5 may comprise at least one passage, such as a groove on the opposite side from the tubular projection 54, which connects the periphery of the base wall 50 and the tubular projection 54 in such a way that gases can circulate in the passage(s) from the exterior toward the interior of the canister 1 when the base wall 50 is applied against a surface. In this way, the canister 1 is still active to regulate the atmosphere e.g. in a container when the base wall 50 lies on a plane surface, such as the bottom of a container in which the canister 1 has been inserted for regulation of its inner atmosphere.

The gas-permeable cap 4 is advantageously obtained by injection molding, through injection of a thermoplastic material in a mold in which the membrane disc 6 has previously been positioned, so as to form the body 5 and simultaneously bond the membrane disc 6 to the distal edge surface 56 of the tubular projection 54 under the effect of the heat and/or the pressure generated during injection molding. To this end, the constitutive materials of the body 5 and the membrane disc 6 are selected to be chemically compatible. By way of a non-limiting example, in this embodiment, the body 5 is made from a high-density polyethylene (HDPE) thermoplastic resin, and the membrane disc 6 is made from TYVEK HBD 1059B manufactured by DUPONT, a non-woven fabric comprising polyethylene fibers.

As can be seen in FIGS. 1 to 3, the tubular projection 54 projects from a face of the base wall 50 which is opposite from the face comprising the injection point 53 for the molding of the body 5. In this way, upon injection molding, the flow of molten thermoplastic material tends to push and immobilize the membrane disc 6 against its supporting surface in the molding apparatus. In order to reduce the risks of damage during release of the gas-permeable cap 4 from the mold, the tubular wall of each tubular projection 54 is tapered from its first end 54a joined to the periphery of the opening 51 toward its second end 54b, with a draft angle a of the order of 0.5°.

In this first embodiment, by way of a non-limiting example:
The height h of the tubular projection 54, relative to the face of the base wall 50 from which it projects and taken perpendicular to the base wall 50, is of the order of 0.5 mm, whereas the thickness t of the membrane disc 6 is of the order of 0.3 mm. As illustrated in FIG. 8, such a height h of the tubular projection, which is higher than the thickness t of the membrane disc 6, ensures that the membrane disc 6 is securely immobilized laterally relative to the mold cavity 14 before the injection of the thermoplastic material.
The width w of the distal edge surface 56 of the tubular projection 54, taken transversally to the longitudinal axis X54 of the tubular projection, is of the order of 1 mm. As illustrated in FIG. 8, such a width w of the distal edge surface 56 ensures that the surface area for the attachment of the membrane disc 6 to the tubular projection 54 is sufficient, while limiting the risk that the periphery of the membrane disc 6 folds into the part 14a of the mold cavity 14 where the distal edge surface 56 is to be formed. Such a folding of the membrane disc 6 at its periphery is to be prevented, to avoid defects in the attachment of the membrane disc 6 which may generate leaks of active material out of the canister.
The distance d between the tubular projection 54 and the portion of the side wall 52 closest to the tubular projection 54 is of the order of 7.5 mm. As illustrated in FIG. 8, such a distance d between the tubular projection 54 and the side wall 52 makes it possible to reinforce the mechanical resistance of the mold part 13 delimiting the mold cavity for the tubular projection 54 and the side wall 52.

FIGS. 4 to 8 show an example of an apparatus 11 for the manufacturing of the gas-permeable cap 4 as described above. The apparatus 11 comprises a mold including a mold cavity 14 for the molding of the body 5 by injection of a thermoplastic material. More precisely, the mold comprises two parts configured to form the mold cavity 14 together, i.e. a first part 12 including a first portion 141 of the wall of the mold cavity 14 and a second core part 13 including a second portion 142 of the wall of the mold cavity 14. The apparatus 11 also comprises a punch 15 configured for the cutting of the membrane disc 6 out of a web 60 of membrane material. To feed the continuous web 60 of membrane material in front of the punch 15, the apparatus 11 comprises a reel to reel system comprising a first reel 18, from which the web 60 is unwound before a cutting operation, and a second reel 19, on which the web 60 is wound after a cutting operation.

The apparatus 11 further comprises a channel 17 connected to the mold cavity 14, which is defined successively, going toward the mold cavity 14, by a punch plate 16 supporting the punch 15 and by the core part 13 of the mold. The punch 15 is configured to slide in the channel 17 from a first position shown in dotted lines in FIG. 5, where it cuts a membrane disc 6 out of the web 60 of membrane material, to a second position, shown in FIGS. 7 and 8, where it closes the mold cavity 14 while being surrounded by the channel 17 and holding the cut membrane disc 6 such that it faces the end 14a of the mold cavity 14 in which the distal edge surface 56 of the tubular projection 54 is to be formed.

A method for manufacturing the gas-permeable cap 4 of the first embodiment by means of the apparatus 11 comprises steps as described below.

First, a membrane disc 6 is cut out of the web 60 of membrane material circulating in front of the punch 15. The punch 15 is configured to cut the membrane disc 6 according to a shape suitable for closing the second end 54b of the tubular projection 54. To this end, starting from the configuration of the apparatus 11 shown in FIG. 4, which corresponds to an open configuration of the mold, the punch plate 16 is moved in the direction of arrow F₁ of FIG. 4 toward the core part 13 of the mold, so that a portion of the web 60 of membrane material is immobilized between the punch plate 16 and the core part 13.

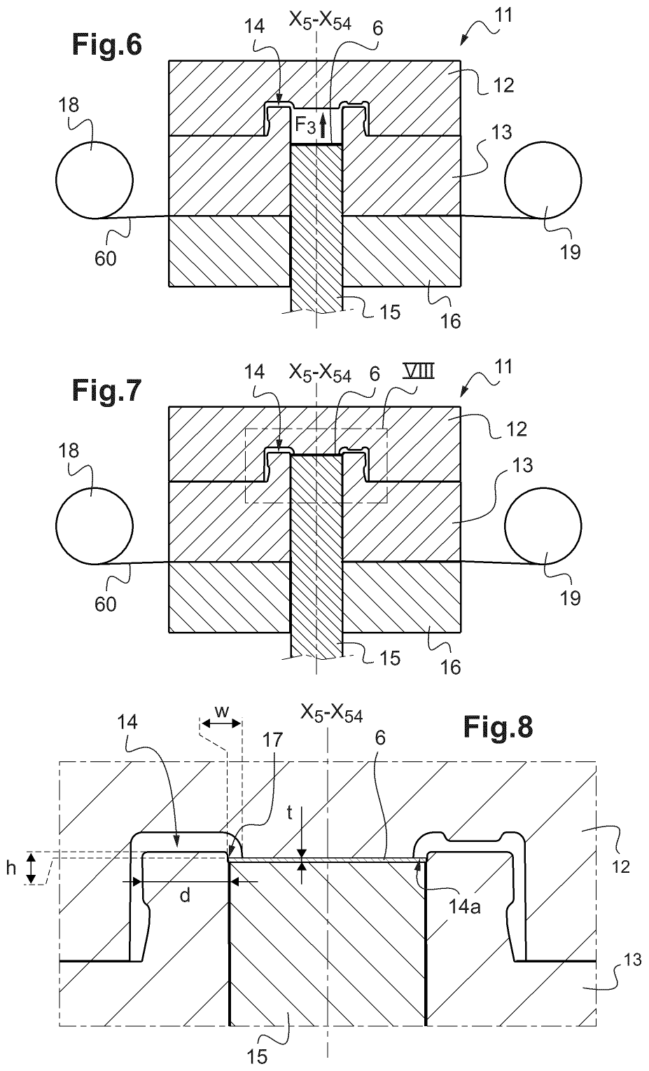

Then, the punch 15 is moved in the channel 17 passing through the punch plate 16 toward the web 60 of membrane material, in the direction of arrow F₃ of FIG. 5, so as to reach the position shown in dotted lines in FIG. 5 where it cuts the membrane disc 6 out of the web 60 of membrane material. After the membrane disc 6 has been cut, the punch 15 is moved further in the channel 17 passing through the core part 13, as shown in FIG. 6. The mold is also closed such that the first part 12 and the core part 13 are in contact with each other and the mold cavity 14 is formed between them. To this end, as shown in FIG. 5, all of the punch plate 16, the core part 13 and the reels 18, 19 are moved in the direction of arrow F₂ of FIG. 5 toward the first part 12 of the mold, so as to reach the position shown in FIG. 6 in which the first part 12 and the core part 13 are in contact with each other and form the mold cavity 14 between them. As a variant, the closing of the mold to reach the configuration shown in FIG. 6 can also be done by moving the first part 12 toward the core part 13.

The closing of the mold to reach the configuration of FIG. 6 may take place before or at the same time as the displacement of the punch 15 according to arrow F₃, provided that the first part 12 and the core part 13 are in contact with each other when the punch 15 reaches its position visible in FIGS. 7 and 8. In this position, the punch 15 closes the mold cavity 14 while being surrounded by the channel 17 and holding the cut membrane disc 6 in its position facing the end 14a of the mold cavity 14 in which the distal edge surface 56 of the tubular projection 54 is to be formed.

Once the cut membrane disc 6 is in its position shown in FIGS. 7 and 8, the constitutive thermoplastic material of the body 5 is injected in the mold cavity 14, so as to form the body 5 and directly bond the membrane disc 6 with the body 5 at the distal edge surface 56 of the tubular projection 54 under the effect of the heat and/or the pressure generated during injection molding. In the position shown in FIGS. 7 and 8, the membrane disc 6 is immobilized relative to the mold cavity 14, in particular thanks to the dimensions h and w of the tubular projection 54. In this way, the quality of the attachment of the membrane disc 6 to the distal edge surface 56 is optimized, which is key for the performance of the gas-permeable cap 4 in terms of limiting the escape of fine particles.

For the manufacturing of a next gas-permeable cap 4, after ejection of the previous gas-permeable cap 4, the apparatus 11 is back in its open configuration shown in FIG. 4. The web 60 of membrane material is advanced from the first reel 18 to the second reel 19, in order to present a new portion of the web 60 of membrane material in front of the punch 15, and the above steps are repeated. Preferably, for the manufacturing of several gas-permeable caps 4, the web 60 of membrane material is cut according to a pattern in which the holes resulting from the cutting of membrane discs 6 are distributed regularly over the surface of the web 60, e.g. in staggered rows. In this way, it is possible to avoid weakening the web 60 of membrane material in a too localized manner, and thus lower the risk that the web of membrane material breaks or deforms when it is displaced between the reels 18 and 19.

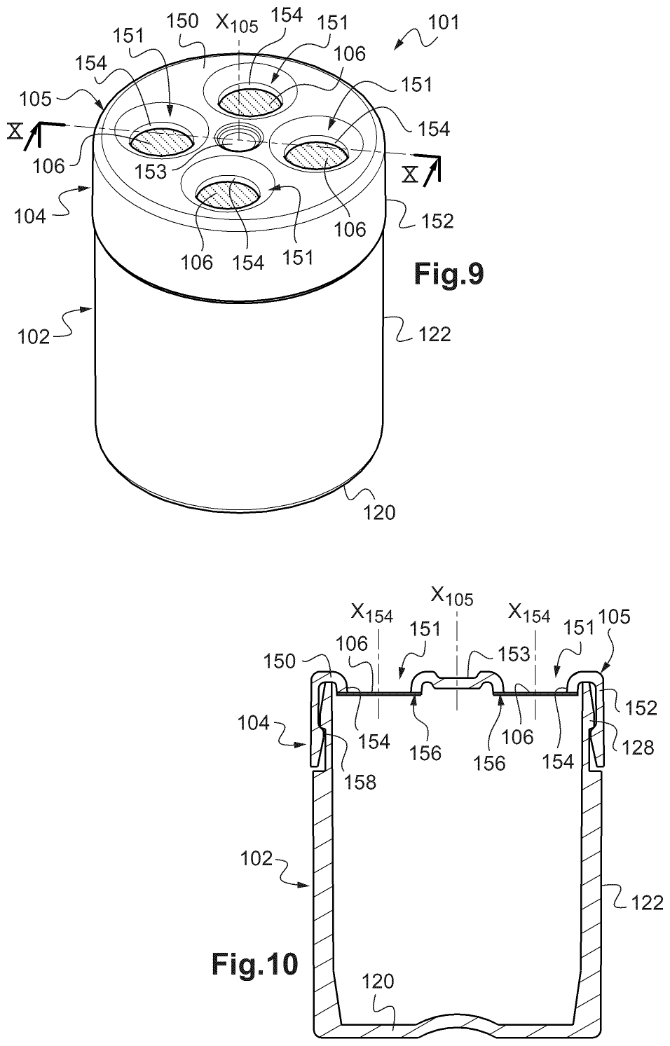

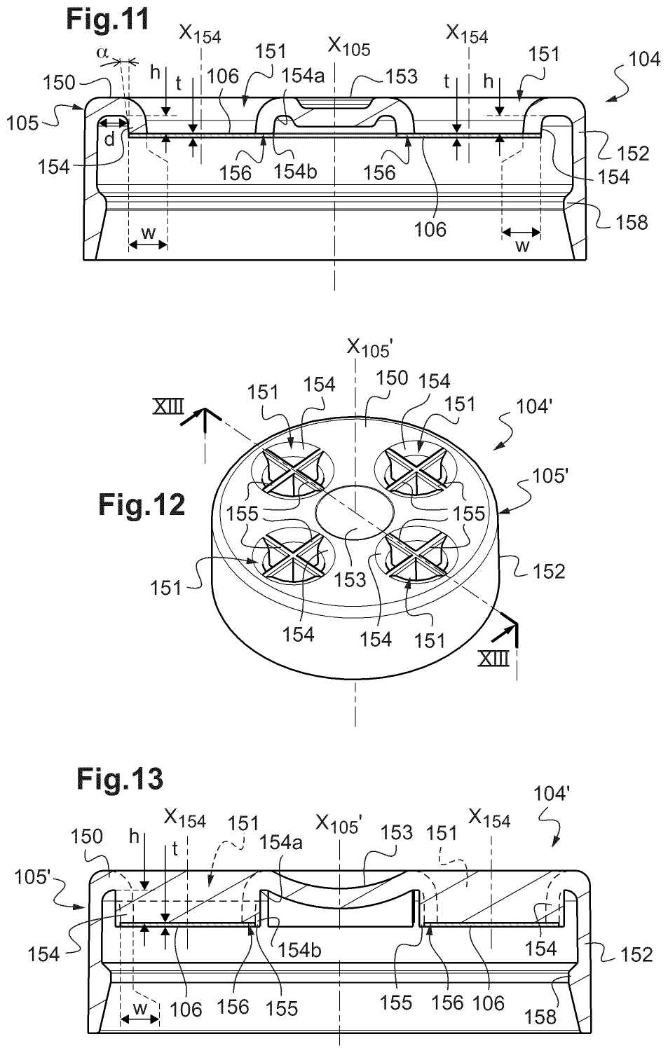

In the second embodiment shown in FIGS. 9 to 11, elements that are similar to those of the first embodiment have the same references increased by 100. The gas-permeable cap 104 of the canister 101 according to the second embodiment comprises a body 105 of tubular shape with a circular cross section, having a base wall 150 and a side wall 152 projecting from the base wall 150 substantially perpendicular thereto. The gas-permeable cap 104 of the second embodiment differs from the first embodiment in that the base wall 150 of the body 105 comprises four openings 151 which are distributed around a center portion of the base wall 150, and the injection point 153 used to produce the body 150 is in a center portion of the base wall 150.

For each opening 151, the body 105 includes a tubular projection 154 projecting from the periphery of the opening 151 substantially perpendicular to the base wall 150. In this way, the longitudinal axis X154 of each tubular projection 154 is parallel to the longitudinal axis X105 of the body 105. The gas-permeable cap 104 also comprises four porous membrane discs 106 each extending across the second end 154b of the corresponding tubular projection while being attached to the distal edge surface 156 at its periphery.

The presence of several openings 151, instead of one central opening as in the first embodiment, can lead to an increase in the exchange surface area between the interior of the canister 101 and the exterior. In this way, the capability of the canister 101 to regulate the atmosphere in a container may be enhanced, by increasing the quantity of gas entering the canister 101 to interact with the active material received therein. In addition, the use of several membrane discs 106 of reduced size, compared to a unique membrane disc 6 of larger size as in the first embodiment, improves the mechanical resistance of the assembly. Moreover, the central position of the injection point 153 ensures a homogeneous injection of the molten thermoplastic material, from the central injection gate toward the periphery of the mold cavity, which makes it easier to produce the gas-permeable cap 104 in a reliable manner by injection molding.

In the second embodiment, by way of a non-limiting example:
The height h of each tubular projection 154, relative to the face of the base wall 150 from which it projects and taken perpendicular to the base wall 150, is of the order of 0.5 mm, whereas the thickness t of each membrane disc 106 is of the order of 0.3 mm.
The width w of the distal edge surface 156 of each tubular projection 154, taken transversally to the longitudinal axis X154 of the tubular projection, is of the order of 1 mm.
The distance d between each tubular projection 154 and the portion of the side wall 152 closest to the tubular projection 154 is of the order of 2 mm.

A method and an apparatus for the manufacturing of the gas-permeable cap 104 according to the second embodiment of the invention can be derived easily from the method and the apparatus described above for the manufacturing of the gas-permeable cap 4 according to the first embodiment. In particular, it is understood that the steps of the method are implemented simultaneously for four membrane discs, by means of four punches 15 which are configured to slide in four channels 17, instead of one membrane disc by means of one punch 15 configured to slide in one channel 17.

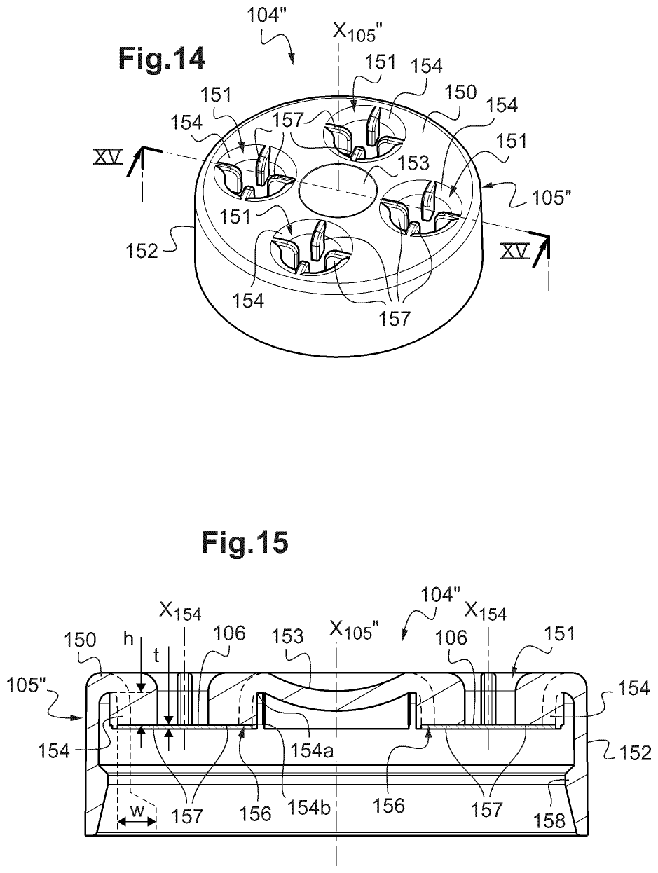

FIGS. 12 to 15 illustrate two variants of the second embodiment in which the body 105′ or 105″ of the gas-permeable cap 104′ or 104″ comprises, for each opening 151 of the base wall 150, transverse ribs 155 or 157 extending across the second end 154b of the tubular projection 154 so as to form an additional attachment surface for the membrane disc 106, which is flush with the distal edge surface 156 of the tubular projection 154. In the first variant shown in FIGS. 12 and 13, the transverse ribs 155 extend over two diameters of the tubular projection 154, in a cross-shaped configuration, which provides an increased bonding surface area for the membrane disc 106 while creating four passages of gases in each tubular projection 154. In the second variant shown in FIGS. 14 and 15, the transverse ribs 157 extend only peripherally with respect to the tubular projection 154, which allows to preserve a higher cross section for the flow of gases through the tubular projection 154 from the exterior toward the interior of the canister 101. For both variants, the fastening of the membrane disc 106 to the body 105′ or 105″ is improved thanks to the increased bonding surface area between the membrane disc and the body. Of course, transverse ribs such as the ribs 155 or 157 shown in FIGS. 12 to 15 can also be provided in the case of a unique opening as in the first embodiment, in order to increase the bonding surface area between the membrane disc 6 and the body 5.

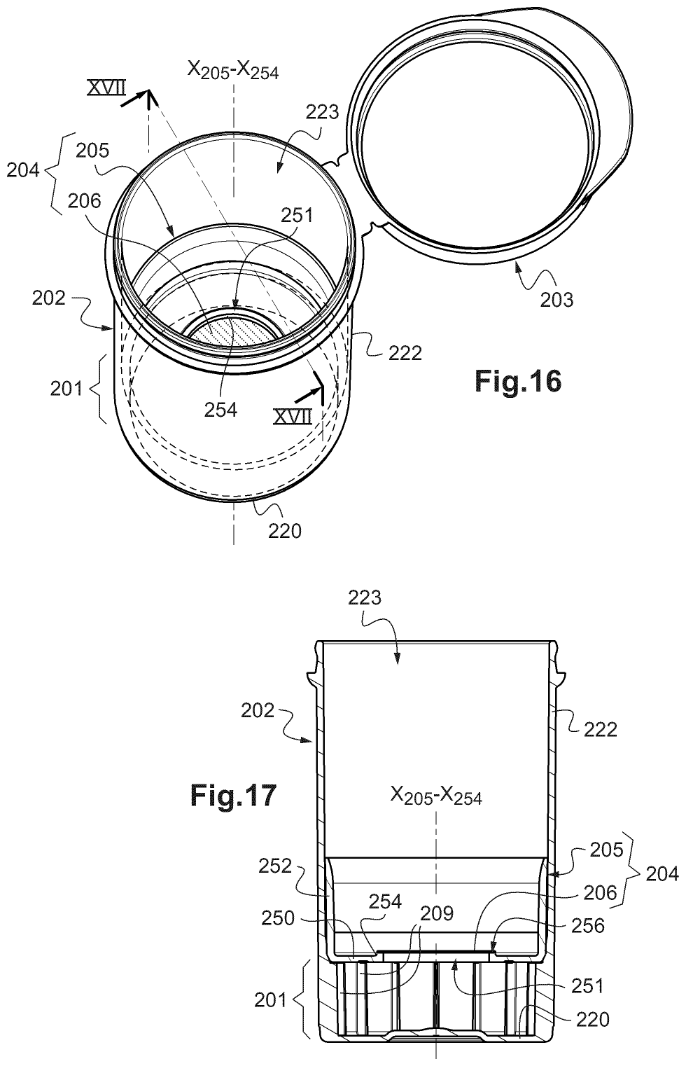

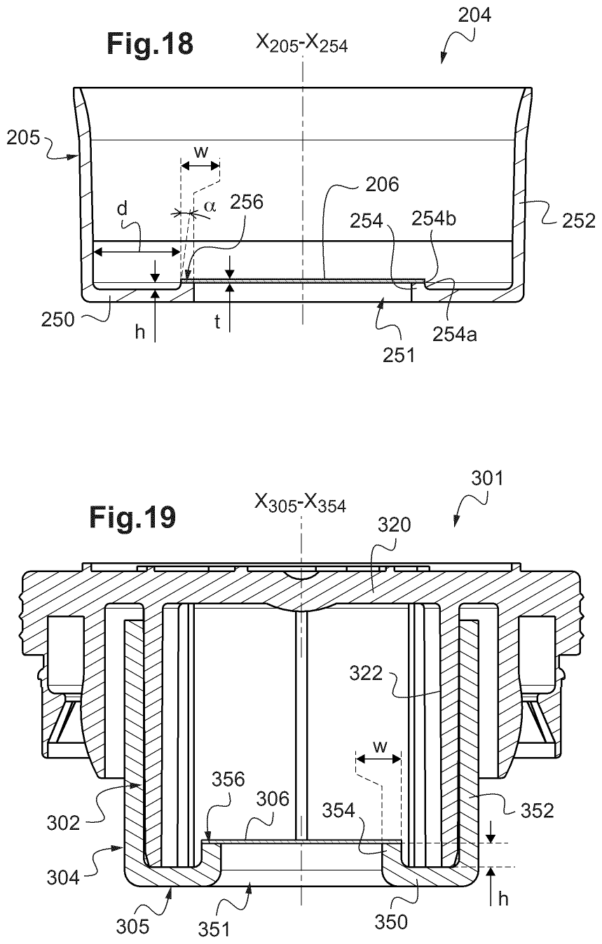

In the third embodiment shown in FIGS. 16 to 18, elements that are similar to those of the first embodiment have the same references increased by 200. In the third embodiment, the gas-permeable element is a gas-permeable cap 204 and the receptacle is a compartment 201 for an active material delimited by the gas-permeable cap 204 in a container intended for the storage of sensitive products, such as diagnostic test strips, or nutraceutical or pharmaceutical products e.g. in the form of pills, lozenges or tablets, notably effervescent tablets. As visible in FIG. 16, the container comprises a tank 202 and a lid 203 for hermetically closing the tank 202. The tank 202 and the lid 203 are connected to each other via a hinge, such as a film hinge. The gas-permeable cap 204 is attached inside the tank 202, e.g. by press fitting, and delimits therein two compartments located on both sides of the gas-permeable cap 204, including the compartment 201 for an active material on one side and a fillable compartment for sensitive products on the other side.

By way of a non-limiting example, the sensitive products received in the fillable compartment may be diagnostic test strips, or nutraceutical or pharmaceutical products e.g. in the form of pills, lozenges or tablets, whereas the active material received in the compartment 201 may be a dehydrating agent (or desiccant) in a powder or granular form, e.g. selected from molecular sieves, silica gels and/or dehydrating clays. As visible in FIGS. 16 and 17, the tank 202 has a circular cross section, and comprises a transverse wall 220, a peripheral wall 222 and an open end 223 on the opposite side from the transverse wall 220, which is configured to be closed by the lid 203. The gas-permeable cap 204 comprises a body 205 and a porous membrane disc 206. The body 205 has a tubular shape with a circular cross section and comprises a base wall 250, a side wall 252 projecting from the base wall 250 substantially perpendicular thereto, and an open end on the opposite side from the base wall 250. The base wall 250 includes a central opening 251 and a tubular projection 254 projecting from the periphery of the opening 251 substantially perpendicular to the base wall 250. In this way, the longitudinal axis X254 of the tubular projection 254 coincides with the longitudinal axis X205 of the body 205. The membrane disc 206 extends across the second end 254b of the tubular projection 254 while being attached to the distal edge surface 256 at its periphery.

The compartment 201 for the active material is delimited by a bottom part of the tank 202 including the transverse wall 220, and it is closed by the gas-permeable cap 204. Advantageously, the gas-permeable cap 204 is positioned in the tank 202 such that the open end of the body 205 faces away from the transverse wall 220. In this way, the inner volume of the gas-permeable cap 204 is part of the fillable compartment for sensitive products, which maximizes the volume available to store sensitive products.

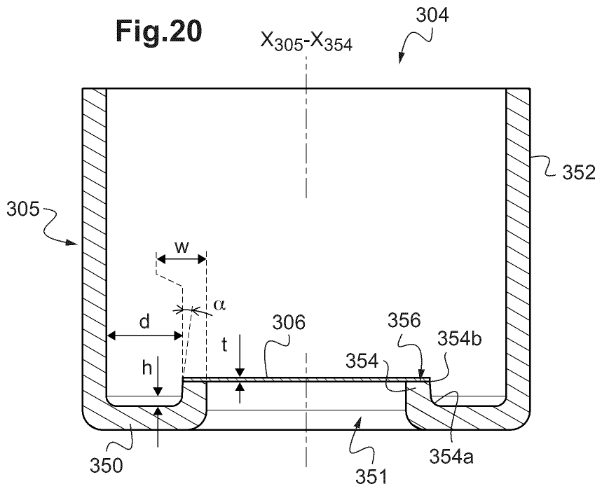

In the fourth embodiment shown in FIGS. 19 and 20, elements that are similar to those of the first embodiment have the same references increased by 300. In the fourth embodiment, the gas-permeable element is a gas-permeable cap 304 and the receptacle is part of a stopper 301 configured to seal a container (not represented) in which sensitive products are stored, and additionally regulate the atmosphere inside the container. As visible in FIGS. 19 and 20, the stopper 301 comprises a tank 302 of circular cross section having a transverse wall 320 and a peripheral wall 322 delimiting a volume for receiving an active material, which is closed by the gas-permeable cap 304. The attachment of the gas-permeable cap 304 relative to the tank 302 is obtained, e.g., by press-fitting.

The gas-permeable cap 304 comprises a body 305 and a porous membrane disc 306. The body 305 has a tubular shape with a circular cross section and comprises a base wall 350, a side wall 352 projecting from the base wall 350 substantially perpendicular thereto, and an open end on the opposite side from the base wall 350. The base wall 350 includes a central opening 351 and a tubular projection 354 projecting from the periphery of the opening 351 substantially perpendicular to the base wall 350. In this way, the longitudinal axis X354 of the tubular projection 354 coincides with the longitudinal axis X305 of the body 305. The membrane disc 306 extends across the second end 354b of the tubular projection 354 while being attached to the distal edge surface 356 at its periphery.

The method and apparatus for the manufacturing of the gas-permeable caps 204, 304 according to the third and fourth embodiments of the invention are similar to those described above for the manufacturing of the gas-permeable cap 4 according to the first embodiment, due to their similar structures.

The invention is not limited to the examples described and shown.

In particular, in the method and apparatus described above for the manufacturing of a gas-permeable element according to the invention, the cutting of each membrane portion is carried out using a punch which is integrated in the injection mold, so that it can position the membrane portion directly in the mold cavity once it has been cut. Such a configuration is very efficient and allows high production rates. However, as a variant, the membrane portion(s) of a gas-permeable element according to the invention may be cut by means of tools which are independent from the injection mold. For example, in an alternative embodiment of the invention, each membrane portion may be cut by laser cutting and the cut membrane portion may then be held by means of a suction pad to be positioned in the mold cavity.

Other shapes and materials than those described above can also be considered for the constitutive parts of a gas-permeable element according to the invention. For example, the or each membrane portion of a gas-permeable element according to the invention may have a shape other than a disc, the condition being that the membrane portion be suitable for closing the second end of the corresponding tubular projection. In addition, the or each membrane portion of a gas-permeable element according to the invention may be made from other materials than a non-woven fabric of polyethylene fibers, e.g. from a non-woven fabric of other polymer fibers, such as polypropylene fibers; a perforated polymer film, such as a film of polyethylene or polypropylene; a metallic fabric or a perforated metallic sheet; etc. In the same way, as mentioned earlier, thermoplastic resins other than high-density polyethylene (HDPE) can be used for the body of a gas-permeable element according to the invention, which may also have different geometries than those described above, for example: the base wall may have any number of openings, in particular a number different from one opening or four openings as described above; each tubular projection may have a cross section other than circular; the distal edge surface of each tubular projection may be inclined relative to the base wall; transverse ribs such as those shown in FIGS. 12 to 15 may be provided with any configuration of the openings and tubular projections of the body; etc.

1. A gas-permeable element to close a receptacle base of a receptacle, wherein the receptacle base contains an active material in its inner volume, wherein the receptacle is suitable for regulation of an atmosphere out of the receptacle, in particular an atmosphere in a packaging or a medical device filled with sensitive and/or odorous products,
wherein said gas-permeable element comprises a body comprising a polymer material, having a base wall including at least one opening,
wherein for each opening of the base wall the body comprises a tubular projection projecting from a periphery of the opening,
wherein the tubular projection comprises a first end connected to the periphery of the opening and a second end defining a distal edge surface transverse to a longitudinal axis of the tubular projection,
wherein a porous membrane portion extends across the second end of the tubular projection and is attached to the distal edge surface at its periphery,
wherein each membrane portion separates the active material from an exterior of the receptacle.

2. The gas-permeable element of claim 1, wherein the base wall of the body comprises at least two openings, distributed around a center portion of the base wall.

3. The gas-permeable element of claim 1, wherein the body is an injection molded part molded over each membrane portion.

4. The gas-permeable element of claim 1, wherein materials of the body and each membrane portion are chemically compatible so that each membrane portion can be bonded to the distal edge surface of the tubular projection under the effect of heat and/or pressure.

5. The gas-permeable element of claim 1, wherein each membrane portion is a polymer membrane portion.

6. The gas-permeable element of claim 1, wherein a height (h) of each tubular projection, taken perpendicular to the base wall, is higher than or equal to a thickness (t) of the membrane portion.

7. The gas-permeable element of claim 1, wherein a width (w) of the distal edge surface of each tubular projection, taken transversally to a longitudinal axis of the tubular projection, is between 0.5 mm and 5 mm.

8. The gas-permeable element of claim 1, wherein for each opening of the base wall, the body further comprises at least one transverse rib extending across the second end of the tubular projection and forming an additional attachment surface for the membrane portion.

9. The gas-permeable element of claim 1, wherein the body includes a side wall projecting from the base wall substantially parallel to each tubular projection, wherein a distance (d) between each tubular projection and a portion of the side wall closest to the tubular projection is at least 2 mm.

10. A receptacle, such as a canister, a stopper or a compartment in a packaging or a medical device,
wherein said receptacle comprises a receptacle base to receive an active material in its inner volume and the gas-permeable element of claim 1 for closing the receptacle base.

11. A method for manufacturing a gas-permeable element configured to close a receptacle base having an active material in its inner volume; wherein said gas-permeable element comprises a body comprising a polymer material, having a base wall with at least one opening and, for each opening, a tubular projection projecting from a periphery of the opening with a first end connected to the periphery of the opening and a second end defining a distal edge surface transverse to a longitudinal axis of the tubular projection;
wherein said gas-permeable element further comprises, for each opening of the body, a porous membrane portion extending across the second end of the tubular projection while attached to the distal edge surface of the tubular projection at its periphery;
wherein said method comprises
molding the body over each membrane portion to be attached to the distal edge surface of a corresponding tubular projection of the body;
wherein said method further comprises
cutting each membrane portion with a shape for closing the second end of the corresponding tubular projection of the body;
positioning each membrane portion in a predetermined position in a mold comprising a mold cavity for the molding of the body, wherein the predetermined position is such that the membrane portion faces an end of the mold cavity in which the distal edge surface of the corresponding tubular projection is formed; and
injecting a thermoplastic material into the mold cavity to form the body and to bond each membrane portion with the body at the distal edge surface of the corresponding tubular projection.

12. The method of claim 11, wherein each membrane portion is cut by a punch, wherein the punch is further used to position the membrane portion in the predetermined position facing the end of the mold cavity and to close the mold cavity before injection of the thermoplastic material.

13. The method of claim 11, wherein each membrane portion is cut out of a web of membrane material circulating in front of a punch for cutting the membrane portion, wherein the web of membrane material extends from a first reel, from which it is unwound before a cutting operation, to a second reel, on which it is wound after a cutting operation.

14. A gas-permeable element obtained by the method of claim 11.

15. An apparatus for the manufacturing of a gas-permeable element of claim 1, comprising:
a mold including a mold cavity for molding of the body by injection of a thermoplastic material;
at least one punch, for cutting a membrane portion out of a web of membrane material;
wherein, for each punch, the apparatus comprises a channel connected to the mold cavity, wherein the punch slides in the channel from a first position, where it cuts a membrane portion, to a second position, where it closes the mold cavity while surrounded by the channel, and holds the cut membrane portion such that it faces an end of the mold cavity in which the distal edge surface of the corresponding tubular projection is formed.

16. The gas-permeable element of claim 5, wherein each membrane portion is a textile comprising polymer fibers or a perforated polymer film.

17. The gas-permeable element of claim 1, wherein a height (h) of each tubular projection taken perpendicular to the base wall is higher than or equal to twice a thickness (t) of the membrane portion.

18. The gas-permeable element of claim 1, wherein a width (w) of the distal edge surface of each tubular projection taken transversely to a longitudinal axis of the tubular projection is between 0.5 mm and 1.5 mm.

19. The gas-permeable element of claim 1, wherein for each opening of the base wall, the body further comprises at least one traverse rib extending across the second end of the tubular projection and forming an additional attachment surface for the membrane portion flush with the distal edge surface.
